(19) United States
(12) Patent Application Publication
(10) Pub. No.: US 2009/0027023 A1
(43) Pub. Date: Jan. 29, 2009

(54) Switching regulator circuit

(76) Inventor: Minoru Sudo, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/284,103

(22) Filed: Sep. 18, 2008

Related U.S. Application Data
(62) Division of application No. 11/333,465, filed on Jan. 17, 2006.

(30) Foreign Application Priority Data
Jan. 19, 2005 (JP) 2005-011235

(51) Int. Cl. G05F 1/10

(52) U.S. Cl. 323/282

(57) ABSTRACT

Provided is a switching regulator having satisfactory energy conversion efficiency during light load conditions. Such a structure is employed that an oscillating frequency for the switching regulator and a drive capability of a switch element are variable and such a control is taken that during the light load, the oscillating frequency for the switching regulator or the drive capability of the switch element is reduced.

### BACKGROUND OF THE INVENTION

1. Field of the Invention

The present invention relates to a switching regulator circuit with which high efficiency is obtained over a wide range of load currents.

2. Description of the Related Art

As a conventional switching regulator circuit of a synchronous rectification type, there is known a circuit shown in FIG. 16 (see Patent Document 1, for example). That is, as shown in FIG. 16, a switching regulator control circuit 50 and a first switch circuit 111 are connected to a power source 10. A second switch circuit 115 is connected between the other end (X terminal) of the first switch circuit and a ground terminal. A commutating diode 114 is connected to the second switch circuit 115 in parallel. A coil 112 is connected to a connection of the first and second switch circuits 111 and 115, and the other end of the coil 112 is connected to an output terminal OUT of the switching regulator. A capacitor 113 is connected between the output terminal OUT and the ground terminal, and further a load 15 is connected between the output terminal OUT and the ground terminal.

While the first switch circuit 111 is electrically conducted, a voltage Vin of the power source 10 input to an input terminal IN is applied to the output terminal OUT via the coil 112 and the first switch circuit 111. To keep an output voltage Vout constant, the output terminal OUT is grounded via a smoothing capacitor 113. In this state, energy accumulates at the coil 112 and a coil current IL flowing in a direction toward the output terminal OUT increases at the coil 112 with an inclination of (Vin−Vout)/L as shown in FIG. 17 (period from Ta to Tb of FIG. 17).

On the other hand, a series circuit of the coil 112 and the smoothing capacitor 113 is disposed with the commutating diode 114 and the second switch circuit 115 in parallel. When the first switch circuit 111 is interrupted (at Tb), a current I flowing through the coil 112 is maintained by the commutating diode 114 and the electrically conducted second switch circuit 115. In this state, the energy accumulated in the coil 112 is discharged and the coil current IL decreases with an inclination of −Vout/L (period from Tb to Tc). At Tc, the first switch circuit 111 is electrically conducted again and energy starts to be accumulated at the coil 112.

The first and second switch circuits 111 and 115 are controlled by the switching regulator control circuit 50. The switching regulator control circuit 50 monitors the output voltage Vout to control a ratio of a continuity period and an interruption period of the first switch circuit 111 to keep the output voltage Vout at a constant value. The first and second switch circuits 111 and 115 are composed of predriver circuits 120 and 124 and MOS transistors 121 and 125 as shown in FIGS. 18A and 18B. Based on a signal Vc from the switching regulator control circuit 50, gate voltages of the MOS transistors 121 and 125 via the predriver circuits 120 and 124 are controlled, thereby turning the switch circuit ON/OFF. The predriver circuits 120 and 124 need to have high drive capabilities to charge/discharge gate capacities of the MOS transistors quickly.

Here, when both the switch circuits 111 and 115 are electrically conducted simultaneously, the input terminal IN is grounded via the switch circuits 111 and 115, with the result that an extremely large feed-through current flows. Therefore, the switching regulator control circuit 50 performs such a control that a predetermined dead time period is prepared between a switching timing for the first switch circuit 111 and that for the second switch circuit 115 to prevent the simultaneous continuity of the switch circuits 111 and 115.

By turning the second switch circuit 1150N, the energy at the coil 112 can be discharged when the first switch circuit 111 is turned OFF, so the commutating diode 114 can be omitted.

In the conventional synchronous rectification circuit, the first and second switch circuits 111 and 115 are turned ON/OFF at a constant frequency. Thus, with a loss due to the switching, efficiency of the circuit largely deteriorates during light load conditions.

The conventional switching regulator circuit has a problem in that, when the load current is small, power conversion efficiency largely decreases.

### SUMMARY OF THE INVENTION

Therefore, the present invention has been made to solve the above-mentioned problem associated with the prior art, and it is an object of the present invention to increase the power conversion efficiency when the load current is small.

According to a first aspect of the present invention, a switching regulator circuit of a synchronous rectification type for alternately turning first and second switch elements on/off includes: a reference voltage circuit for generating a reference voltage; a dividing circuit for diving a voltage output from a switching regulator; an error amplifier for inputting the voltage of the dividing circuit the voltage of the reference voltage circuit and amplifying a voltage obtained as a difference between a voltage of the dividing circuit and the reference voltage; an oscillating circuit for outputting an oscillating signal; a PWM comparator for comparing the output voltage of the error amplifier and an output voltage of the oscillating circuit; the first switch element for controlling a coil current of the switching regulator; and the second switch element for commutating an energy of the coil, in which a frequency of the oscillating circuit and at least one of drive capabilities (ON resistances) of the first and second switch elements is changed based on an external signal.

In the first aspect of the present invention, the drive capabilities (ON resistances) of the first and second switch elements and the drive capabilities (ON resistances) of the first and second predriver circuits for driving the first and second switch elements are simultaneously changed.

In the first aspect of the present invention, when the frequency of the oscillating circuit is reduced, at least one of the drive capabilities of the first and second switch elements are simultaneously reduced, that is, the ON resistance is increased.

In the first aspect of the present invention, the frequency of the oscillating circuit and the drive capabilities (ON resistances) of the first and second switch elements are changed according to a load current of the switching regulator.

According to a second aspect of the present invention, a switching regulator circuit of a synchronous rectification type for alternately turning first and second switch elements on/off includes: a reference voltage circuit for generating a reference voltage; a dividing circuit for diving a voltage output from a switching regulator; a first error amplifier circuit for inputting a voltage of the dividing circuit and the reference voltage and amplifying a voltage obtained as a difference between the voltages; an oscillating circuit for outputting an oscillating signal; a PWM comparator for comparing the output voltage of the first error amplifier circuit and an output voltage of the oscillating circuit; a transistor connected between an output of the switching regulator and a power source; a second error amplifier circuit for inputting the voltage of the dividing circuit and the reference voltage and amplifying a voltage obtained as a difference between the voltages; a first switch element for controlling a coil current of the switching regulator; and a second switch element for commutating an energy of the coil, in which operation of the switching regulator is stopped and a gate voltage of the transistor connected between the output of the switching regulator and the power source is controlled by using the output of the second error amplifier circuit based on an external signal.

In the second aspect of the present invention, the operation of the switching regulator is stopped and the gate voltage of the transistor connected between the output of the switching regulator and the power source is controlled according to a load current of the switching regulator.

The switching regulator circuit according to the present invention provides an effect of improving the power conversion efficiency obtained when the load current is small.

### BRIEF DESCRIPTION OF THE DRAWINGS

In the accompanying drawings:

FIG. 1 shows a switching regulator according to a first embodiment of the present invention;

FIG. 2 shows a switching regulator control circuit according to the first embodiment of the present invention;

FIG. 3 is a block diagram of a switch element 1 according to the present invention;

FIG. 4 is a block diagram of a switch element 2 according to the present invention;

FIG. 5 shows a current waveform according to the first embodiment of the present invention;

FIG. 6 is a block diagram of a switch element 1 according to a second embodiment of the present invention;

FIG. 7 is a block diagram of a switch element 2 according to the second embodiment of the present invention;

FIG. 8 is a block diagram of the switch element 1 according to the second embodiment of the present invention;

FIG. 9 is a block diagram of the switch element 2 according to the second embodiment of the present invention;

FIG. 10 shows a switching regulator according to a third embodiment of the present invention;

FIG. 11 shows an example of a load current detecting circuit;

FIG. 12 shows a switching regulator according to a fourth embodiment of the present invention;

FIG. 13 shows a switching regulator control circuit according to the fourth embodiment of the present invention;

FIG. 14 shows a switching regulator according to a fifth embodiment of the present invention;

FIG. 15 is a block diagram of the switch element 2 according to the present invention;

FIG. 16 shows a conventional switching regulator;

FIG. 17 shows a current waveform of the conventional switching regulator; and

FIGS. 18A and 18B show an example of a switch circuit of the conventional switching regulator.

### DETAILED DESCRIPTION OF THE PREFERRED EMBODIMENTS

To solve the above-mentioned problem, in a switching regulator of the present invention, when a load is light, a switching frequency is reduced and also a drive capability of a switch element is reduced. When the load is light, operation of the switching regulator is stopped and power is supplied from a voltage regulator to the load.

### First Embodiment

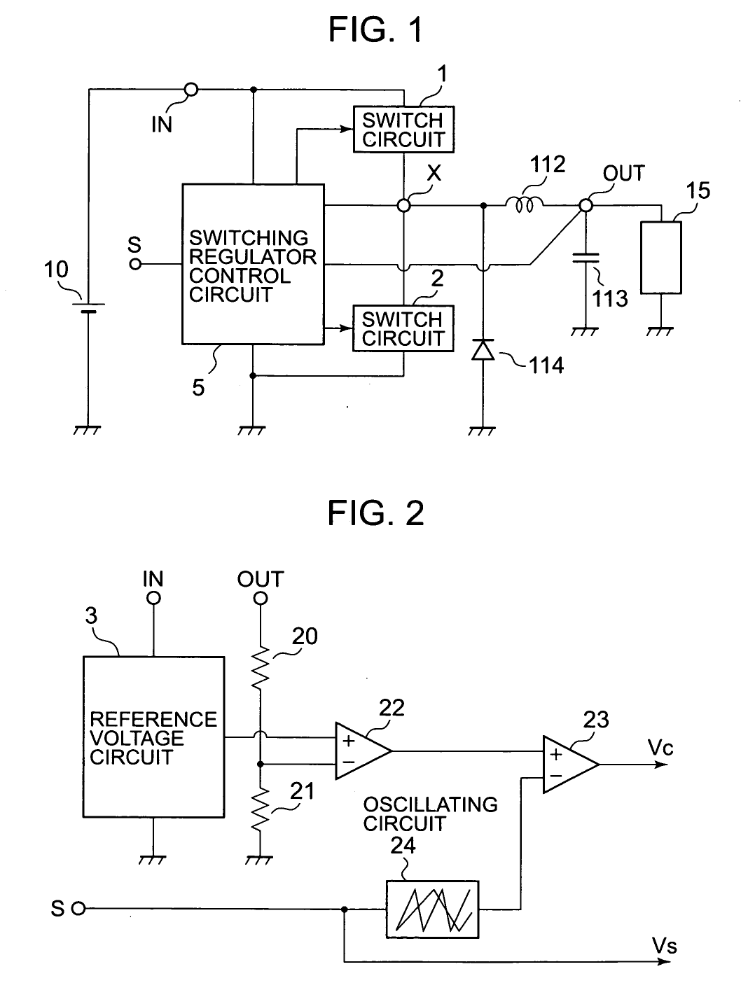

Hereinafter, embodiments of the present invention will be described based on the drawings. FIG. 1 shows a switching regulator according to a first embodiment of the present invention. The difference from the conventional example of FIG. 16 resides in that a switching regulator control circuit 5 includes an input terminal S for an input from outside. A first switch circuit 1 including a switch element and a second switch circuit 2 including a switch element change drive capabilities of the respective switch elements based on a signal from the switching regulator control circuit 5. Further, when an oscillating frequency inside the switching regulator control circuit 5 changes based on a voltage of the input terminal S, the drive capabilities of the first and second switch elements 1 and 2 change simultaneously.

FIG. 2 is a block diagram of the switching regulator control circuit 5 of the present invention. A reference voltage circuit 3 outputs a constant voltage. A dividing circuit composed of resistors 20 and 21 for dividing the voltage is connected to an output terminal OUT of the switching regulator. Also, there are provided an error amplifier 22 for amplifying a voltage obtained as the difference between the output voltage of the dividing circuit and that of the reference voltage circuit 3, and a comparator 23 for comparing the output of the error amplifier 22 and that of an oscillating circuit 24. The oscillating circuit 24 generates a chopping wave of a certain frequency. The comparator 23 compares the output of the error amplifier 22 and that of the oscillating circuit 24 to generate an output signal Vc, thereby driving the switch elements.

When a voltage Vout of the output terminal of the switching regulator is lower than a desired voltage, the output of the error amplifier 22 increases, and as a result, “H” level period of the output signal Vc of the comparator 23 is extended. If the output signal Vc of the comparator 23 is “H” level, when the switch element of the first switch circuit 1 is turned ON, by increasing ON duty of the switch element of the first switch circuit 1, such a control works that the voltage of the output terminal is kept constant when the voltage Vout of the output terminal of the switching regulator is lower than a desired voltage.

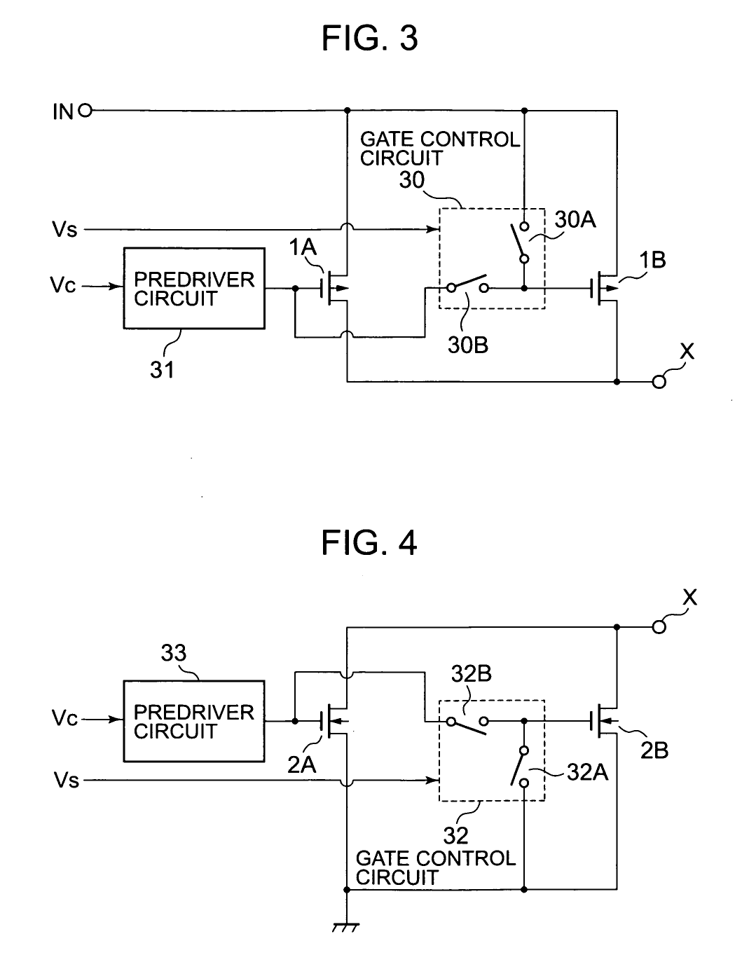

In the switching regulator of the present invention, when the oscillating frequency of the oscillating circuit 24 changes based on the voltage Vs of the input terminal S, the drive capability of the switch element changes simultaneously. FIG. 3 is a block diagram of the switch element 1 of the present invention. The switch element 1 includes a predriver circuit 31 for driving the switch element, MOS transistors 1A and 1B as switch elements, and a gate control circuit 30. A terminal IN is connected to the power source 10 and a terminal X is connected to a connection of the coil 112, the commutating diode 114, etc. The predriver circuit 31 buffers the output voltage Vc of the comparator 23 and drives gates of the MOS transistors 1A and 1B at low impedance to control ON/OFF of the MOS transistors 1A and 1B. The gate control circuit 30 connects a gate of the transistor 1B to the output of the predriver circuit 31 or the power terminal IN by the voltage Vs of the input terminal S.

The MOS transistors 1A and 1B have different drive capabilities, namely, ON resistances, and when the resistance of the MOS transistor 1A is set as R_{1A} and the resistance of the MOS transistor 1B is set as R_{1B}, the following relation is satisfied:

R_{1A}>>R_{1B} (1)

For example, when the voltage Vs of the input terminal S is “H” level, the switch 30B of the gate control circuit 30 is turned ON and the switch 30A is turned OFF, and simultaneously the oscillating frequency of the oscillating circuit 24 of FIG. 2 is set to be high (ex. 1 MHz). In this state, the MOS transistors 1A and 1B both perform ON/OFF-turning based on the output of the predriver circuit 31.

Next, when the voltage Vs of the input terminal S is “L” level, the switch 30A of the gate control circuit 30 is turned ON and the switch 30B is turned OFF, and simultaneously the oscillating frequency of the oscillating circuit 24 of FIG. 2 is set to be low (ex. 10 kHz). In this state, the MOS transistor 1B is turned OFF and the MOS transistor 1A performs ON/OFF-turning based on the output of the predriver circuit 31. The switches 30A and 30B are composed of MOS transistors and ON/OFF-turning of the switches 30A and 30B is performed by controlling gate voltages of the MOS transistors.

That is, when the load is light, the voltage Vs of the input terminal S is processed to “L” level, the switching frequency reduces, and charge/discharge of a gate capacity of the MOS transistor 1B, which becomes a load on the predriver circuit 31, is no longer necessary. Thus, the switching loss can be reduced.

Similarly, FIG. 4 is a block diagram of the switch element 2. A terminal X is connected to the terminal X of FIG. 3. The switch element 2 includes a predriver circuit 33 for driving the switch element, the MOS transistors 2A and 2B, and a gate control circuit 32. The predriver circuit 33 buffers the output voltage Vc of the comparator 23 and performs ON/OFF-turning of the gates of the MOS transistors 2A and 2B at low impedance. The gate control circuit 32 connects the gate of the MOS transistor 2B to the output of the predriver circuit 33 or a ground terminal.

The MOS transistors 2A and 2B have different drive capabilities, namely, ON resistances, and when the resistance of the MOS transistor 2A is set as R_{2A} and the resistance of the MOS transistor 2B is set as R_{2B}, the following relation is satisfied:

R_{2A}>>R_{2B} (2)

An ON resistance Ron of the MOS transistor is inversely proportional to a gate width W in an unsaturated area. That is, when the gate width W is large with respect to a certain gate length L, the ON resistance of the MOS transistor decreases, while when the gate width W is small with respect to a certain gate length L, the ON resistance of the MOS transistor increases. That is, when the ON resistance of the MOS transistor is large, it means that the gate width W is small. In general, the gate capacity of the MOS transistor is proportional to the gate width W, so when the ON resistance is large, the gate capacity of the MOS transistor is small.

When the voltage Vs of the input terminal S is “H” level, the switch 32B of the gate control circuit 32 is turned ON and the switch 32A is turned OFF, and simultaneously the oscillating frequency of the oscillating circuit 24 shown in FIG. 2 is set to be high (ex. 1 MHz). In this state, the MOS transistors 2A and 2B both perform ON/OFF-turning based on the output of the predriver circuit 33.

Next, when the voltage Vs of the input terminal S is “L” level, the switch 32A of the gate control circuit 32 is turned ON and the switch 32B is turned OFF, and simultaneously the oscillating frequency of the oscillating circuit 24 of FIG. 2 is set to be low (ex. 10 kHz). In this state, the MOS transistor 2B is turned OFF and the MOS transistor 2A performs ON/OFF-turning based on the output of the predriver circuit 33. The switches 32A and 32B are composed of MOS transistors and ON/OFF-turning of the switches 32A and 32B is performed by controlling gate voltages of the MOS transistors.

That is, when the load is light, the voltage Vs of the input terminal S is processed to “L” level, the switching frequency reduces, and charge/discharge of a gate capacity of the MOS transistor 2B, which becomes a load on the predriver circuit 33, is no longer necessary. Thus, the switching loss can be reduced.

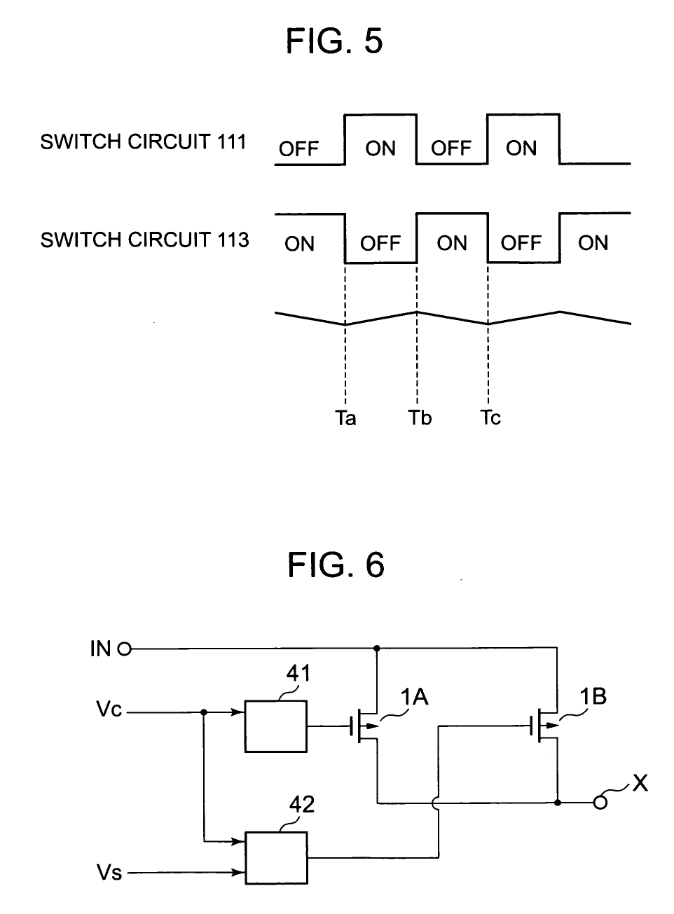

Here, when the oscillating frequency is decreased by the voltage Vs of the input terminal S, the drive capabilities of the switch circuits 1 and 2 reduce (ON resistances increase). Therefore, similar to the conventional example, no coil current flows. That is, according to the conventional example, in the switching regulator circuit, to reduce the switching loss, only the ON resistances of the switches are reduced. However, in the present invention, when the oscillating frequency is reduced, the ON resistances of the switches are increased. In other words, when the switch element 1A is turned ON and the switch element 1B is turned OFF, the current IL flowing at the coil 112 in a direction toward the output terminal OUT is not (Vin−Vout)/L×t with respect to a time T unlike the conventional example, but the following expression is obtained as shown in FIG. 5:

IL=(Vin−Vout)/(L×t+R_{1A}) (3)

If L×t<<R_{1A}, the following expression is obtained:

IL=(Vin−Vout)/R_{1A} (4)

From the expression (4), when the ON resistance R_{1A} of the MOS transistor 1A is large, the coil current IL does not largely depend on the time and is a substantially constant current determined by the ON resistance R_{1A} of the MOS transistor 1A (period from Ta to Tb of FIG. 5). Similarly, when the switch element 1A is turned OFF, the switch element 2A is turned ON, and the switch element 2B is turned OFF, the current IL flowing at the coil 112 in the direction toward the output terminal OUT is not ˜Vout/L×t with respect to the time T unlike the conventional example, but the following expression is obtained as shown in FIG. 5:

IL=−Vout/(L×t+R_{2A}) (5)

If L×t<<R_{2A}, the following expression is obtained:

IL=−Vout/R_{2A} (6)

From the expression (6), when the ON resistance R_{2A} of the MOS transistor 2A is large, the coil current IL does not largely depend on the time and is a substantially constant current determined by the ON resistance R_{2A} of the MOS transistor 2A (period from Tb to Tc of FIG. 5).

Generally, in the synchronous rectification circuit, the coil current IL is proportional to the time based on IL=−Vout/L×t, with the result that the current increases in a minus direction. Depending on the time t, even after the coil energy is discharged, a current flows from the output terminal Vout to the ground terminal via the switch element. However, according to the expression (6), even if a current flows, its current value is suppressed due to the ON resistance R_{2A} of the MOS transistor 2A.

In the above description, if the commutating diode 114 exists, when the switch circuit 1 is turned OFF, a current flows to the commutating diode 114 as well as the switch circuit 2, and the expression (6) is not obtained. Therefore, a diode having a high resistance (a resistor is inserted in series to the commutating diode) or no diode is used as the commutating diode 114.

Next, the effect of improving the energy conversion efficiency of the switching regulator is described. In the switching regulator, when the loss reduces, the energy conversion efficiency improves. If the switching loss in the switching at 1 MHz (including a loss from driving the switch element) is 100 mW, only by setting the switching frequency to 10 kHz ( 1/100), the switching loss becomes 1 mW ( 1/100). Further, by increasing the ON resistor of the switch element, the charge/discharge amount of the gate capacity becomes small, so the switching loss can be reduced to 0.1 mW or lower. On the other hand, by increasing the ON resistance of the switch element, the following loss Psw caused by the switch element occurs.

Psw=(Vin−Vout)²/R_{1A}×Ton+Vout²/R_{2A}×Toff (7)

Where Ton is an ON duty of the MOS transistor 1A and Toff is an OFF duty of the MOS transistor 1A (1−Ton).

That is, values of R_{1A} and R_{2A} are determined to satisfy Psw+0.1 mW<100 mW, so it can be said that the effect of improving the energy conversion efficiency of the switching regulator is obtained.

### Second Embodiment

FIG. 6 is a block diagram of the switch circuit 1 of the switching regulator according to a second embodiment of the present invention.

The difference from FIG. 3 resides in that predriver circuits 41 and 42 exist instead of the predriver circuit 31 and the gate control circuit 30 is deleted. The predriver circuit is a circuit for driving switch elements. To drive a large-scale switch element, a predriver circuit assumedly needs to have high drive capability. In general, the higher the drive capability is, the lager the switching loss is. The predriver circuit 41 is a circuit for driving the MOS transistor 1A and the predriver circuit 42 is a circuit for driving the MOS transistor 1B. Similar to FIG. 3, the MOS transistors 1A and 1B have different drive capabilities, namely, ON resistances. When the ON resistance of the MOS transistor 1A is R_{1A} and the ON resistance of the MOS transistor 1B is R_{1B}, the expression (1) is satisfied. Therefore, the switching loss of the predriver circuit 41 for driving the MOS transistor 1A is smaller than that of the predriver circuit 42. The sum of both the losses is substantially equal to the loss of the predriver circuit 31 of FIG. 3. In FIG. 3, both the switch elements 1A and 1B are driven by the predriver circuit 31. When the switch element 1B is turned OFF by the voltage Vs of the input terminal S, operation of the predriver circuit 42 is also stopped. When the operation of the predriver circuit 42 is stopped, the switch element 1B is turned OFF. In this way, while the switch element 1B is turned OFF, unnecessary predriver operation is stopped and the loss of the predriver circuit 42 can be cut.

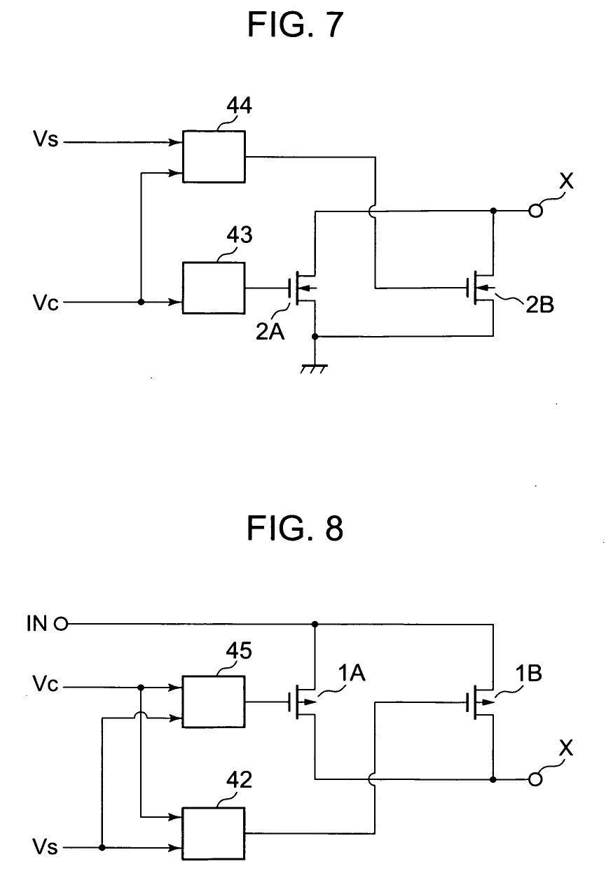

Similarly, FIG. 7 is a block diagram of the switch circuit 2 of the switching regulator according to the second embodiment of the present invention. The difference from FIG. 4 resides in that predriver circuits 43 and 44 exist instead of the predriver circuit 33 and the gate control circuit 32 is deleted.

Similar to FIG. 6, operation of the predriver circuit 44 is stopped when the switch element 2B is turned OFF by the voltage Vs of the input terminal S. In this manner, while the switch element 2B is turned OFF, unnecessary predriver operation is stopped and the loss of the predriver circuit 44 can be cut.

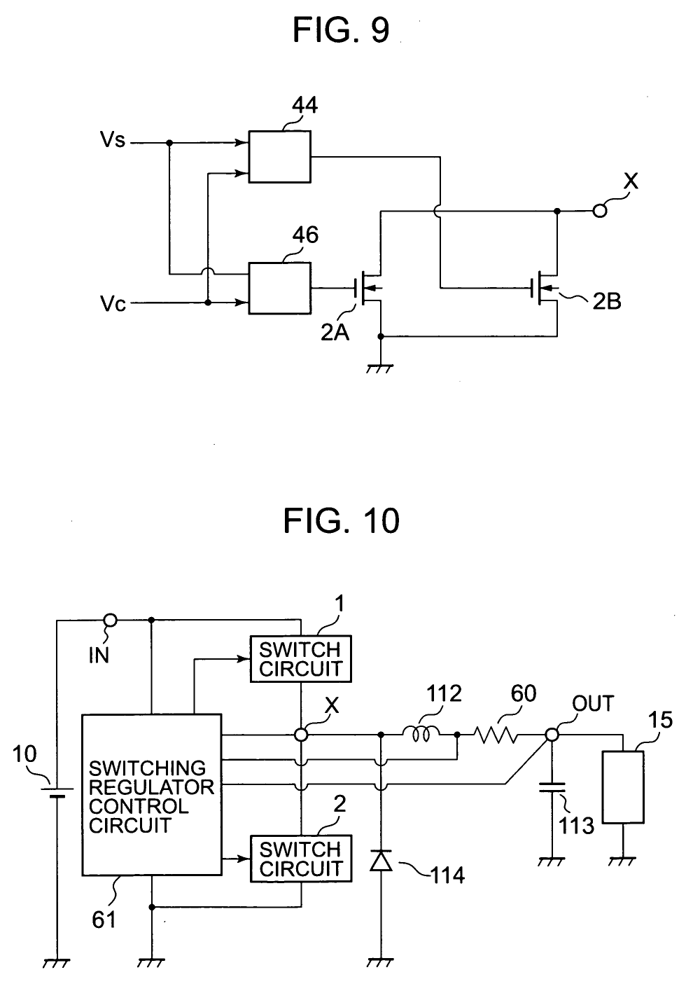

Instead of FIGS. 6 and 7, as shown in FIGS. 8 and 9, the switch element 1A or 1B and the switch element 2A or 2B can also be performed by the voltage Vs of the input terminal S. The difference between FIGS. 6 and 8 resides in that the predriver circuit 41 is changed into a predriver circuit 45 and similarly the difference between FIGS. 7 and 9 resides in that the predriver circuit 43 is changed into a predriver circuit 46.

That is, in FIG. 8, when the switch element 1A is operated by the voltage Vs of the input terminal S, a predriver circuit 45 is operated to turn the switch element 1A ON/OFF. At that time, the switch element 1B is turned OFF to stop the predriver circuit 42 too. Next, when the voltage Vs of the input terminal S has the opposite logic, the predriver circuit 42 is operated to turn the switch element 1B ON/OFF. At that time, the switch element 1A is turned OFF to stop the predriver circuit 45 too.

When the load is light, the switch element having the higher drive capability and the predriver circuit for driving the switch element are turned off, thereby reducing the switching loss during light load conditions.

### Third Embodiment

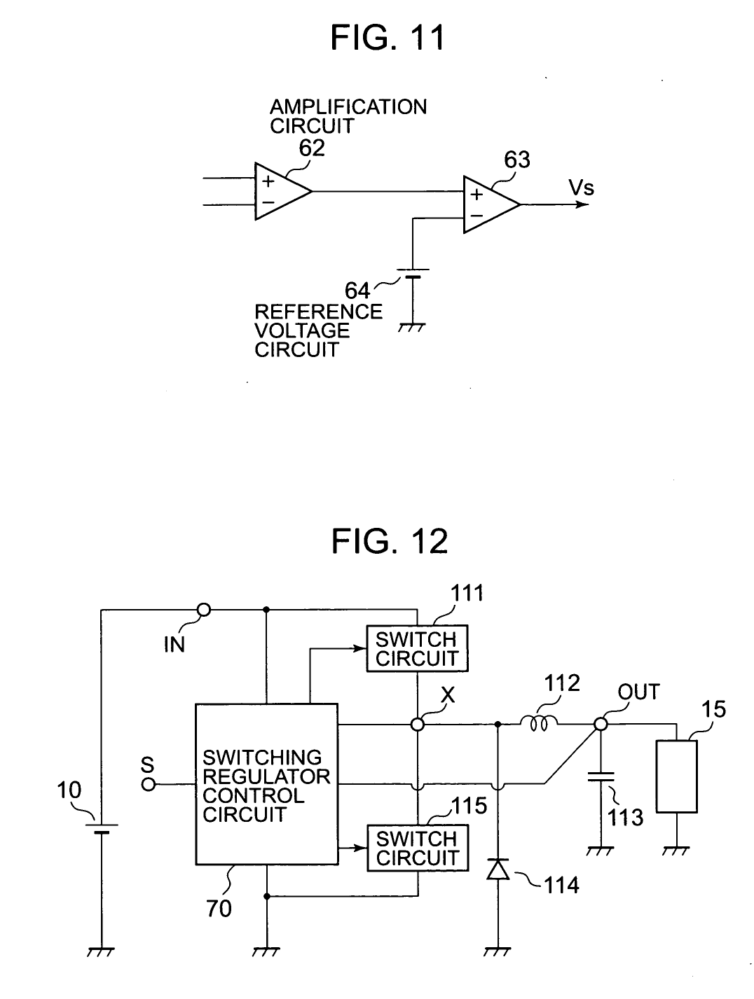

FIG. 10 shows a switching regulator according to a third embodiment of the present invention. The difference from FIG. 1 resides in that the input terminal S is omitted and a current sense resistor 60 is added between the coil 112 and the output terminal OUT. Signals at both ends of the current sense resistor are connected to a switching regulator control circuit 61. In the switching regulator control circuit 61, as shown in FIG. 11, an amplifying circuit 62 amplifies a voltage of the ends of the resistance. The voltage is compared with that of a reference voltage circuit 64 at a comparator 63. An output of the comparator is set as the signal Vs, which is the input from outside in FIG. 1. Thus, when the load current is large, an output of the amplifying circuit 62 increases, and when the load current is small, the output of the amplifying circuit 62 decreases. When the load current is equal to or lower than a certain value, the output of the comparator 63, namely, Vs, is “L” level, with the result that the oscillating frequency of the switching regulator control circuit 61 reduces and the drive capability of the switch element reduces.

In this way, without external control, the oscillating frequency automatically reduces according to the load current when the load is light, and the drive capability of the switch element reduces, thereby improving the efficiency.

### Fourth Embodiment

FIG. 12 shows a switching regulator according to a fourth embodiment of the present invention. The difference from the conventional example of FIG. 16 resides in that a switching regulator control circuit 70 includes the input terminal S for the input from outside. Such a control is taken that the oscillating operation of the switching regulator control circuit 70 stops and simultaneously a path transistor between the output terminal OUT and the input terminal IN of the switching regulator is controlled to keep the voltage Vout of the output terminal OUT constant.

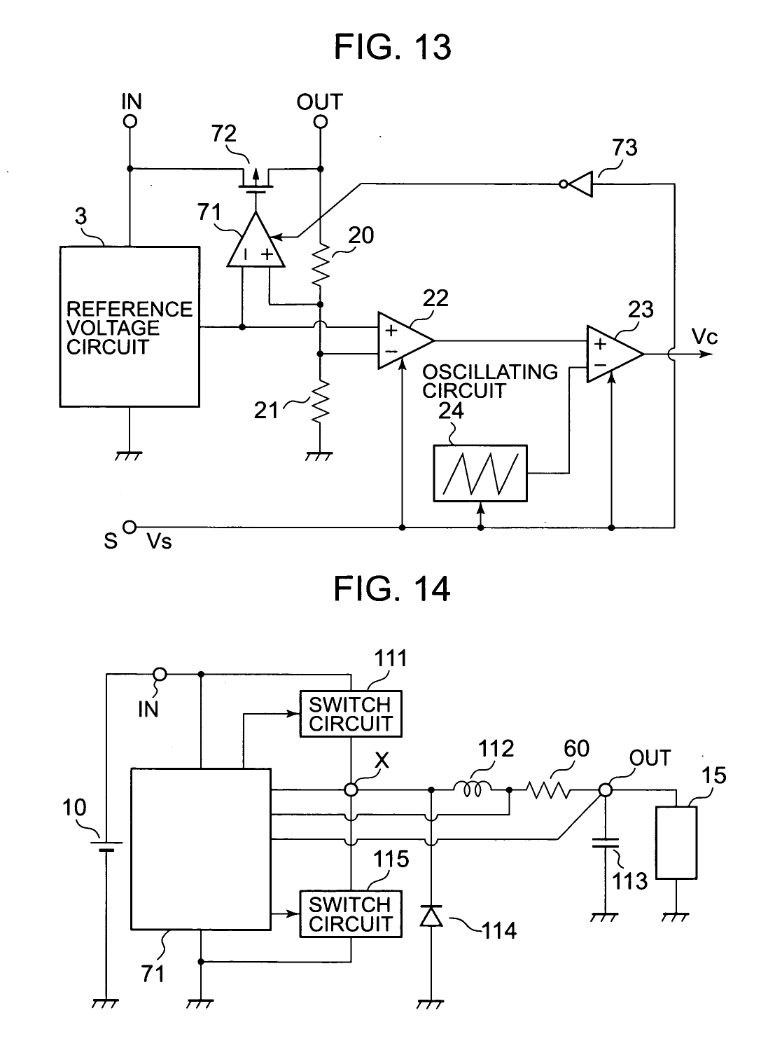

FIG. 13 is a block diagram of the switching regulator control circuit 70. The reference voltage circuit 20, the dividing circuit composed of the resistors 20 and 21, the error amplifier 22, and the comparator 23 are the same as those of FIG. 2. However, ON/OFF control is performed on the oscillating circuit 24, the error amplifier 22, and the comparator 23 by the voltage Vs of the input terminal S (the oscillating circuit 24 is controlled only by the voltage Vs of the input terminal S and the oscillating frequency is not changed unlike the case of FIG. 2). ON/OFF control is performed on a second error amplifier 71 by a signal obtained by inverting the signal of the voltage Vs of the input terminal S by an inverter 73. The second error amplifier 71 controls a gate voltage of a path transistor 72. When the oscillating circuit 24, the error amplifier 22, and the comparator 23 are turned OFF and the switch circuits 111 and 115 are electrically unconducted, with the result that operation as the switching regulator stops. After logical signal processing with the signal of the voltage Vs of the input terminal S, when the voltage Vs of the input terminal S is “L” level, the switch circuits 111 and 115 can be electrically unconducted.

If the voltage Vs of the input terminal S is “H” level, the oscillating circuit 24, the error amplifier 22, and the comparator 23 are turned ON. If the normal operation of the switching regulator continues, the error amplifier 71 is turned OFF at that time and then the path transistor 72 is turned OFF. If the voltage Vs is “L” level, the oscillating circuit 24, the error amplifier 22, and the comparator 23 are turned OFF. A series regulator composed of the error amplifier 71, the path transistor 72, the reference voltage circuit 3, and the dividing resistors 20 and 21 operates to perform a control for keeping the voltage Vout of the output terminal OUT constant.

In general, when the series regulator has a large input/output voltage difference, the loss increases. If the input voltage is twice as large as the output voltage, the energy conversion efficiency of about 50% is obtained even when the operation current of the series regulator is suppressed. However, the switching regulator may often have the efficiency of 50% or less due to the switching loss during light load conditions.

The energy conversion efficiency during light load conditions can be improved by switching the operation from the switching regulator to the series regulator.

### Fifth Embodiment

FIG. 14 shows a switching regulator according to a fifth embodiment of the present invention.

The difference from FIG. 12 resides in that the input terminal S is omitted and the current sense resistor 60 is added between the coil 112 and the output terminal OUT. Signals at both ends of the current sense resistor are connected to a switching regulator control circuit 71. The amplifying circuit 62 amplifies a voltage of the ends of the resistance in the switching regulator control circuit 71 as shown in FIG. 11. The voltage is compared with that of the reference voltage circuit 64 at the comparator 63. An output of the comparator is set as the signal Vs, which is the input from outside in FIG. 10. Thus, when the load current is large, an output of the amplifying circuit 62 increases, and when the load current is small, the output of the amplifying circuit 62 decreases. When the load current is equal to or lower than a certain value, the output of the comparator 63, namely, Vs, is “L” level, with the result that the oscillating circuit 24, the error amplifier 22, and the comparator 23 are turned OFF and the series regulator composed of the error amplifier 71, the path transistor 72, the reference voltage circuit 3, and the dividing resistors 20 and 21 is turned ON to perform a control for keeping the voltage Vout of the output terminal OUT constant.

Thus, according to the load current, when the load is light, without control by the external terminal, the switching operation automatically stops and the series regulator operates, thereby improving the efficiency.

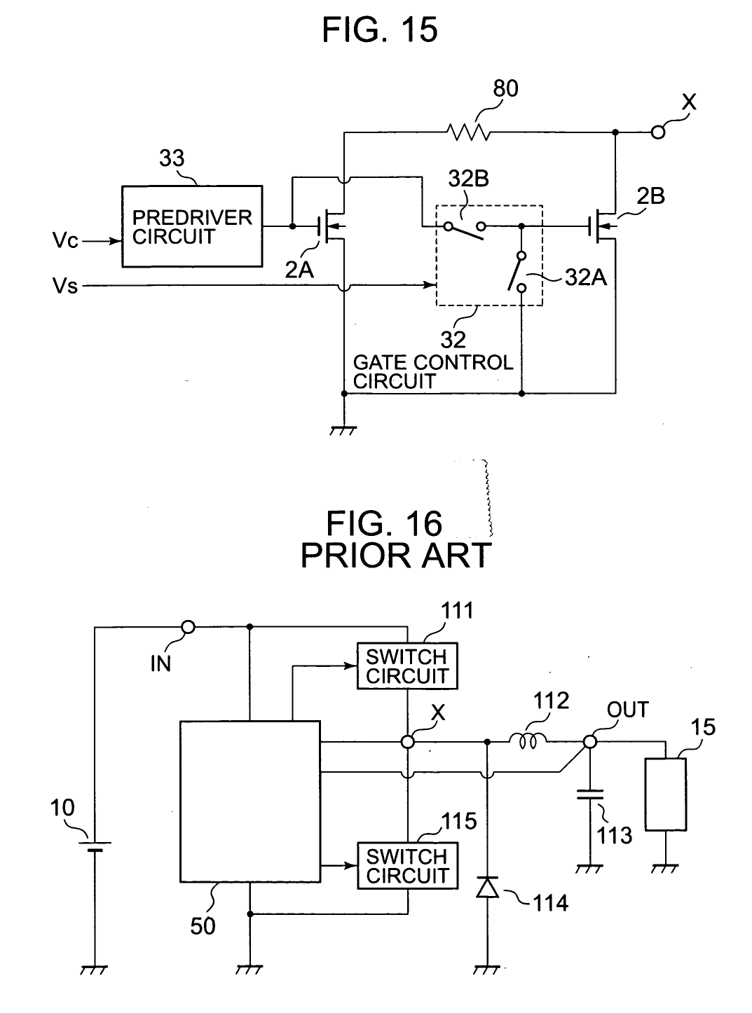

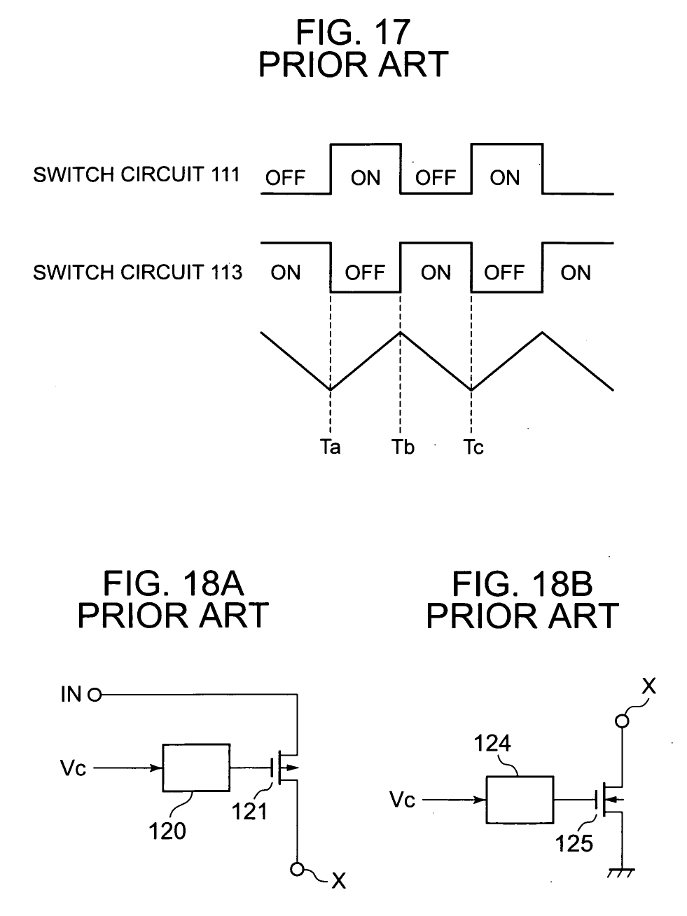

When the switch element is composed of the MOS transistor, the ON resistance of the switch element can be controlled by its gate width and gate length, but by adding a resistor to the switch element in series, its resistance value can be used. FIG. 15 shows an example where the resistor is added to the switch element in series. The difference from FIG. 4 resides in that a resistor 80 is inserted between a drain of the switch element 2A and the terminal X. Thus, a resistance value between a source of the switch element 2A and the terminal X can be set as the sum of the ON resistance value of the switch element 2A and the resistance value of the resistor 80. This method is obviously applicable to FIGS. 3, 6, and 7.

As described above, according to the present invention, in the switching regulator, the power conversion efficiency during light load conditions can be improved.

The switching regulator of the present invention can be used as a technique for improving the power conversion efficiency during light load conditions.

### DESCRIPTION OF REFERENCE NUMERALS

1, 2 switch circuit
3 reference voltage circuit
5 switching regulator control circuit
24 oscillating circuit
30, 32 gate control circuit
31, 33 predriver circuit
61, 70 switching regulator control circuit
62 amplification circuit
64 reference voltage circuit
111, 115 switch circuit

1.-5. (canceled)

6. A switching regulator circuit of a synchronous rectification type for alternately turning first and second switch elements on/off, comprising:
a reference voltage circuit for generating a reference voltage;
a dividing circuit for diving a voltage output from a switching regulator;
a first error amplifier circuit for inputting a voltage of the dividing circuit and the reference voltage and amplifying a voltage obtained as a difference between the voltages;
an oscillating circuit for outputting an oscillating signal;
a PWM comparator for comparing an output voltage of the first error amplifier circuit and an output voltage of the oscillating circuit;
a transistor connected between an output of the switching regulator and a power source;
a second error amplifier circuit for inputting the voltage of the dividing circuit and the reference voltage and amplifying a voltage obtained as a difference between the voltages;
a first switch element for controlling a coil current of the switching regulator;
a second switch element for commutating an energy of the coil; and
means for stopping operation of the switching regulator and controlling a gate voltage of the transistor connected between the output of the switching regulator and the power source by using the output of the second error amplifier circuit, based on an external signal.

7. A switching regulator circuit according to claim 6, wherein the operation of the switching regulator is stopped and the gate voltage of the transistor connected between the output of the switching regulator and the power source is controlled according to a load current of the switching regulator.
